(19) United States
(12) Patent Application Publication
(10) Pub. No.: US 2014/0098532 A1
(43) Pub. Date: Apr. 10, 2014

(54) Multiple Diode LED Flameless Candle

(71) Applicant: Hsui Ching Chiang, Irvine, CA (US)

(72) Inventor: Hsui Ching Chiang, Ludao Township (TW)

(21) Appl. No.: 14/047,527

(22) Filed: Oct. 7, 2013

Related U.S. Application Data
(60) Provisional application No. 61/711,322, filed on Oct. 9, 2012.

(51) Int. Cl. F21S 10/04

(52) U.S. Cl. CPC F21S 10/04
USPC 362/235; 362/249.05

(57) ABSTRACT

A battery powered device simulating a traditional wick burning candle through the combined use of a multiple diodes in one LED, electronic circuit board and integrated chip to control the flicker pattern of the said LED. The battery compartment and electronic circuits are contained within an internal housing which is placed within the body of a simulated candle shell. The multiple diodes in one LED is extended through an opening in the upper portion of the candle shell. Switches to operate the said device are placed on the bottom base of the internal housing, which is exposed on the bottom of the candle.

### BACKGROUND OF THE INVENTION

1. Technical Field of the Invention

The present invention relates generally to battery operated LED (light emitting diode) candles, commonly referred to as “flameless candles”, and in particular, to the LED of such candle containing multiple diodes that function independent of each other during operation.

2. Description of the Related Art

Various configurations of LED flameless candles are known in prior art. Typically, such prior art devices use either one (1) single diode LED or multiple single diode LEDs to achieve the desired lighting effect to simulate a natural candle flame. A drawback of the one (1) single diode LED is the relatively unrealistic “flicker effect”, which is a natural consequence of having only one light source. Multiple single diode LED flameless candles have better flicker effect but at an increased cost due to the use of multiple single diode LEDs. Another drawback of this configuration is the bulkiness of the LEDs, which must be clustered together. This arrangement typically forgoes the use of any cosmetic cover, known as a flamecap, to mask the LEDs, as is frequently used in one LED configurations. The relative bulk of the LED cluster would not make such a cover realistic in appearance. Flameless candles typically use “dome” shaped LEDs which tend to create a spotlight or beam of light directed straight out the top of the flameless candle, which is not an effective use of light in a simulated candle application.

The drawbacks mentioned above have not been adequately addressed by prior art. It is the intention of the present invention to remedy, at least in part, these deficiencies.

### SUMMARY OF THE INVENTION

Accordingly, there is provided herein, in various embodiments, a flameless candle incorporating the use of a multiple diode in one LED. The multiple diode in one LED is mounted onto an internal housing that also contains electronic circuit components to control the aforementioned independent flickering of each diode within the LED. For clarification, “multiple diodes” as defined is more than one (1) diode per LED unit. The independent flickering of the individual diodes within the LED allow for a more realistic simulation of a candle flame. The internal housing also contains the batteries as well as various operational switches such as for power, timer functions and remote control among others. The internal housing ideally is positioned within an artificial candle shell, which may be constructed of wax, plastic, resin or other suitable material. Further, the location of the multiple diode in one LED is such that it is below the top lip of the candle shell and above the partition of the candle shell and the top of the internal housing (referred to as the “shelf” in the industry). This exposes the position of the multiple diode in one LED to the external portion of the candle shell while keeping it in a position to cast illumination through the side wall of the candle shell creating “glow” in the candle shell.

In another aspect of the foregoing embodiment, the shape of the multiple diode in one LED is concave. An LED is covered by a plastic lens. This lens not only protects the delicate electronic diode of the LED, but it is influential in determining the light pattern that is cast when the LED is operational. The multiple diodes in one LED will use a concave shape lens. The lens contains an inverted cone design directly opposite of the location of the diodes which effectively acts as a reflector to redirect light to the side of the LED rather than allowing it to project straight. The use of this shape LED lens along with the multiple diodes in one LED improves the illumination and ambience of a flameless candle.

In another aspect of the invention, the multiple diodes in one LED is constructed using only two posts; one negative and one positive. The use of this format allows for a more compact LED size that physically matches the size of a typical single diode LED. This compact size will allow the use, if needed, of a flamecap to conceal direct viewing of the LED without forcing the flamecap to take on unrealistic proportions to effectively conceal the multiple diodes in one LED.

In another aspect of the invention, the flickering effect is controlled with an integrated chip (IC) built into the LED, which is the preferred embodiment of the present invention. It is also possible to develop an independent integrated chip that would not be positioned within the LED but rather placed on the electronic circuit board or other location to actuate a flickering pattern.

In another aspect of the invention, it is envisioned that power could be supplied by various means, including but not limited to, rechargeable batteries via removable A/C power adaptor. hard wired A/C power and solar power. It is also contemplated that the device could incorporate features such as a timer to allow for auto on and off operation, remote control to allow for operation of the candle unit from a distance, and light sensing technology to allow unit to automatically turn on whenever ambient light levels are sufficiently low.

### BRIEF DESCRIPTION OF THE SEVERAL VIEWS OF THE DRAWINGS

A more complete understanding of the invention may be had by reference to the following detailed description when taken in conjunction with the accompanying drawings, wherein:

FIG. 1 shows a perspective and cut-away view of a preferred embodiment of the invention;

FIG. 2 shows a cross sectional view of the preferred embodiment of the multiple diode in one LED referenced in FIG. 1;

FIG. 3 shows alternative orientation of the multiple diode layouts for the multiple diode in one LED shown in FIG. 2;

FIG. 4 shows electronic schematic of the wiring for the multiple diode in one LED shown in FIG. 2 and FIG. 2;

Where used in the various figures of the drawings, the same reference numerals designate the same or similar parts. Furthermore, when the terms “front,” “back,” “first,” “second,” “upper,” “lower,” “height,” “top,” “bottom,” “outer,” “inner,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will either be explained or will be within the skill of persons of ordinary skill in the art after the following teachings of the present invention have been read and understood. Further, the exact dimensions and dimensional proportions to conform to specific width, length, and similar requirements will likewise be within the skill of the art after the following teachings of the present invention have been read and understood.

Preferred embodiments of the multiple diode in one LED flameless candle according to the present invention will now be described in detail with reference to the accompanying drawings.

### DETAILED DESCRIPTION OF THE DRAWINGS

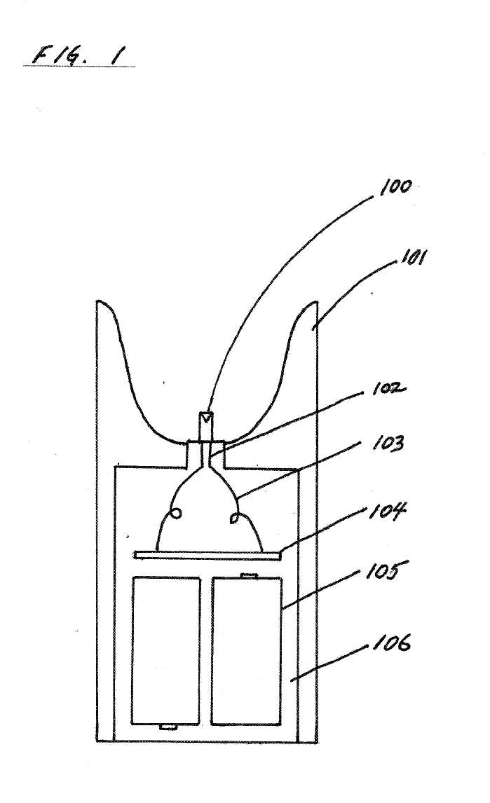

Referring to FIG. 1, a cross sectional view of a preferred embodiment of the multiple diode in one LED flameless candle is shown. The multiple diode in one LED (100) is attached to an internal housing (106). The anode and cathode leads (102) of the multiple diode in one LED (100) are connected to an electronic circuit board (104) via wires (103) or via direct connection such as soldering (not shown). The internal housing (106) also contains the power source such as batteries (105) as well as operation switches (not shown). Collectively, these components are contained within the simulated candle shell (101) to complete the preferred embodiment of the device. The preferred embodiment of the present invention uses wax for the candle shell for a realistic simulation. It is also considered that plastic, resin or other suitable materials can be used to effectively simulate a candle shell. It is also considered that alternative embodiments of the device could include use of rechargeable batteries powered by a removable A/C power adaptor, be hard wired for A/C power or contain solar power panels. Likewise, those of ordinary skill in the art will recognize that other alternate embodiments of the invention intended primarily for outdoor use is possible as is alternative uses when combined with other lighting accessories associated with candle application such as lanterns, hurricanes, sconces, and chandeliers

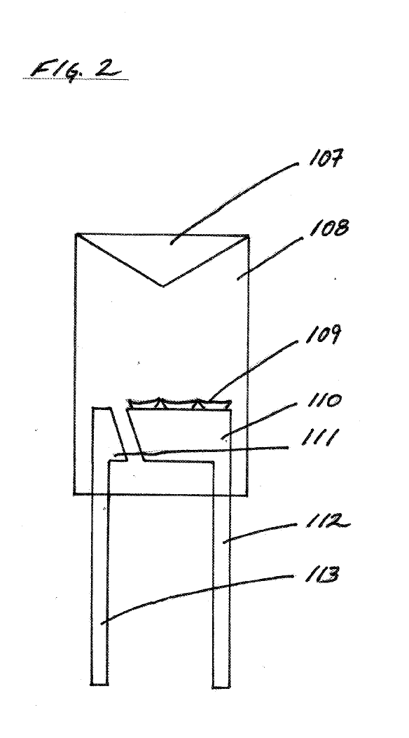

Referring to FIG. 2, the preferred embodiment of the device includes as a light source a multiple diode in one LED. The multiple diodes in reflectors (109) are attached to the one side of the LED. In FIG. 2 these are shown attached to the anvil (110), which becomes the cathode, or negative lead (112). On the other side, the post (111) becomes the anode, or positive lead (113). This assembly in encased in a plastic lens (108). The shape of the lens in the preferred embodiment is concave. A concave lens has a conical indentation (107) at the top of the lens which effectively redirects light out the side of the lens rather than out the top of the lens. It may be possible under some applications to alter the shape of the lens, such as a dome shape (not shown) to tailor light performance to meet specific applications.

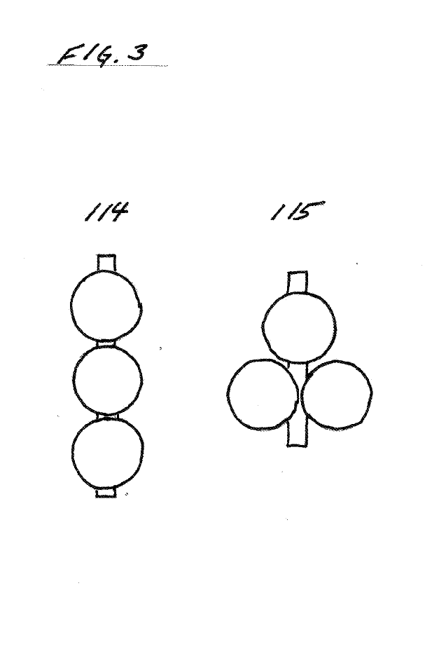

Referring to FIG. 3, there are alternative orientations of the multiple diodes that have been considered, two of which are shown. In the preferred embodiment of the present invention the multiple diodes are oriented in a straight line along the top of the anvil as shown in a top down view (114). It is also possible to arrange the diodes in other orientations such as a triangular layout along the top of the anvil as shown in a top down view (115). While the orientations shown reference three diodes, it is possible to consider other configurations based on how many diodes are used.

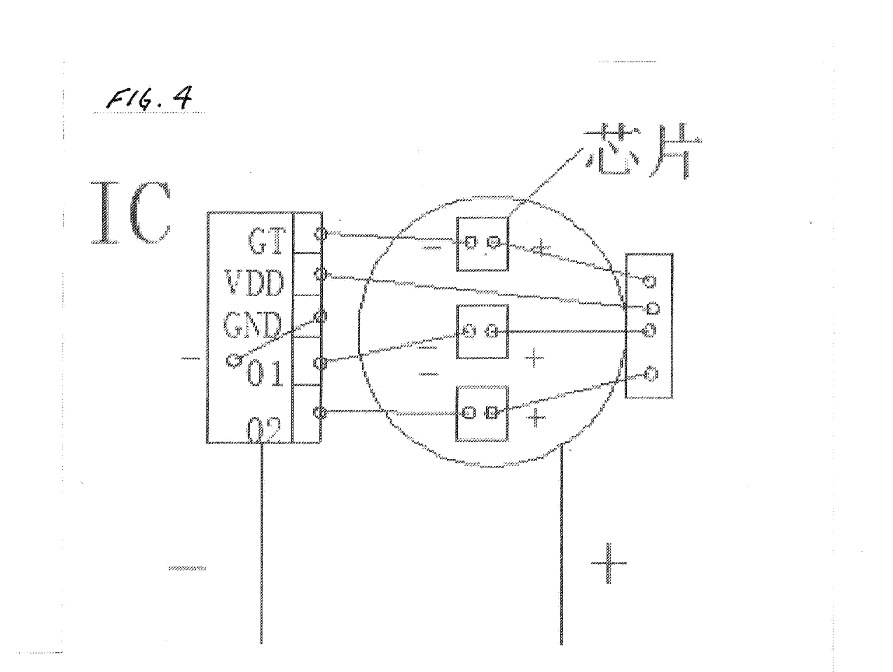

Referencing FIG. 4, there are considerations to the electronic layout of the multiple diode in one LED. The figure shows electrical connections to multiple diodes as well as an integrated chip (IC). The preferred embodiment of the present invention incorporates these elements onto an LED with two leads (− and +). Three diodes and their respective connections are shown, although multiple diodes could include any quantity which is more than one diode.

What is claimed:

1. A simulated candle (known as a flameless candle) device comprising:
(a) a multiple diodes in one LED mounted to an internal housing of said device;
(b) an electronic circuit board to which the multiple diodes in one LED is connected inside of said internal housing unit;
(c) one or more switches connected to said electronic circuit board and; one or more switches controlling power to said electronic circuit board and said multiple diodes in one LED; and
(d) a simulated candle shell within which the said internal housing, electronic circuit board and multiple diodes in one LED are mounted; wherein the multiple diodes in one LED create a realistic simulation of a natural candle flame with the unit is powered on.

2. The multiple diodes in one LED device of claim 1, wherein the multiple diodes in one LED are connected to the power source via a single anode (+ lead) and a single (− lead).

3. The multiple diodes in one LED device of claim 1, wherein the multiple diodes in one LED are housed inside a concave shaped lens.

4. The multiple diodes in one LED device of claim 1, wherein the multiple diodes are controlled via an electronic circuit to intermittently illuminate at least one of said light emitting diodes independently of other said light emitting diodes to provide a flame-like flickering effect.

5. The multiple diodes in one LED lighting device of claim 1 wherein said device is connected to a power source selected from a group consisting of: one or more batteries, rechargeable batteries with removable A/C power source, a hard wired A/C power source, or solar cells.

6. The multiple diodes in one LED lighting device of claim 1 wherein said one or more switches are mounted to a control unit, said control unit being operable by a user of said device to activate said device.
